(19) United States
(12) Patent Application Publication
(10) Pub. No.: US 2010/0302799 A1
(43) Pub. Date: Dec. 2, 2010

(54) Moving light effect using a light-guide structure

(75) Inventors: Christian Romer Rosberg, Copenhagen (DK); Casper Angelo, Copenhagen (DK); Herman Scherling, Kokkedal (DK)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/455,209

(22) Filed: May 29, 2009

(51) Int. Cl. F21V 8/00

(52) U.S. Cl. 362/602

(57) ABSTRACT

A plurality of light sources are arranged with a light-guide structure such that light emitted by the sources propagates longitudinally through the light-guide structure. The light-guide structure scatters and/or redirects the emitted light and outputs the scattered and/or redirected light laterally. A controller is configured to dynamically correlate the light emitted from the plurality of light sources and to dynamically tune intensity of the light emitted from the plurality of light sources. The result is a dynamic light effect that appears to the observer as moving light.

### TECHNICAL FIELD

The exemplary and non-limiting embodiments of this invention relate generally to light-guides and to coordinating light emanating from multiple sources to create the visual effect of movement. Particular embodiments relate to light emitting diodes (LEDs) based illumination deployed on mobile devices such as mobile telephone devices.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

It is known to sequence light emanating from multiple light sources to mimic the effect of movement. For brevity consider this generally to be dynamic light effects. True dynamic light movement effects would typically require physical movement of the light source itself, with the attendant mechanical sub-structures to do so. Prior art implementations typically mimic movement of the light source through closely spaced LEDs that sequence on and off in a coordinated fashion so that the observing person perceives the sequencing light as a moving light source (or multiple moving sources). In practice such prior art implementations rely on various combinations of on/off blinking and/or fading/breathing scenarios to mimic the specific movement desired. The use of display technologies (e.g., a pixilated display for a personal computer for example) operates on the same underlying concept, but using discrete pixels instead of discrete LED sources.

This is shown generally at FIG. 1, in which a series of ten LED are in a single row underneath a light diffuser. When they are sequentially lit up from left to right, with timing such that as each new LED is lit another LED that was previously lit up is depowered, the observing person perceives a single light source moving left to right along the arrow indicated. Note that the chain of LED sources are oriented to emit light in the direction perpendicular to the apparent trajectory of the moving light (as that trajectory is observed by the human observer). The bar shown over the LEDs in FIG. 1 serves as a light diffuser, so the sequentially actuated LEDs are not seen as individual sources but rather as a diffused brightness that smoothly moves laterally. The diffuser is relatively thick to serve that purpose. That diffuser then does not operate as a light-guide.

One particular prior art reference, Korea patent application10-2003-0056778 (published Mar. 3, 2005), concerns an arrangement of light sources and light-guides and describes in its translated abstract:
A mobile terminal having a light guide emitting function is provided to obtain a brilliant light-emitting effect with a small number of light-emitting sources by installing a light guide containing an optical fiber at a terminal housing in order to project light, generated from light-emitting sources, such as LEDs, to the optical fiber using it as a light source. CONSTITUTION: A mobile terminal comprises a light-emitting part and a light guide (100). The light-emitting part comprises a plurality of light-emitting sources that emit light. The light guide (100) comprises an optical fiber (110) receiving and propagating the light emitted from the light-emitting part. The light guide (100) comprises an end lighting part (112). The optical fiber (110) is cut so that the light guide can comprise the end light part (112) formed at the output terminal of the optical fiber (110).

### SUMMARY

In a first aspect the exemplary embodiments of this invention provide a method which comprises: dynamically tuning light intensity from a plurality of correlated light sources; and emitting the dynamically tuned light intensities longitudinally into a light-guide structure which is configured to scatter and/or re-direct the emitted light and to output the scattered and/or re-directed light laterally.

In a second aspect the exemplary embodiments of this invention provide an apparatus comprising a plurality of light sources, a light-guide structure, and a controller. The light-guide structure is disposed to longitudinally propagate light emitted by the plurality of light sources through at least a portion of the light-guide structure, and it is configured to scatter and/or re-direct the emitted light and to output the scattered and/or re-directed light laterally. The controller is configured to a) dynamically correlate the light emitted from the plurality of light sources and to b) dynamically tune intensity of the light emitted from the plurality of light sources.

In a third aspect the exemplary embodiments of this invention provide a computer readable memory storing a program of machine readable instructions that when executed by a controller result in actions comprising: dynamically tuning light intensity from a plurality of correlated light sources; and emitting the dynamically tuned light intensities longitudinally into a light-guide structure which is configured to scatter and/or re-direct the emitted light and to output the scattered and/or re-directed light laterally.

In a fourth aspect the exemplary embodiments of this invention provide an apparatus comprising a plurality of lighting means, light-guiding means, and controlling means. The light-guiding means is for longitudinally propagating light emitted by the plurality of lighting means through at least a portion of the light-guiding means. The light-guiding means is also for scattering and/or re-directing the emitted light and for outputting the scattered and/or re-directed light laterally. The controlling means is for dynamically correlating light emitted from the plurality of lighting means and for b) dynamically tuning intensity of the light emitted from the plurality of lighting means. In a particular embodiment, the lighting means are each an LED, the light guiding means is a polymer light-guide, and the controlling means is a digital controller. In another particular embodiment the lighting means are ultraviolet light sources, and the light guiding means is a light-guide with fluorescing volume scattering nodes or fluorescing outcoupling structures or the light-guiding means is a light-guide made of a fluorescing material.

### BRIEF DESCRIPTION OF THE DRAWINGS

FIG. 1 is a schematic diagram of a prior art arrangement of LEDs and light diffuser for producing a dynamic lighting effect.

FIGS. 2A-B are schematic diagrams illustrating dynamically tuned light intensity from two correlated LEDs according to an exemplary embodiment of the invention.

FIGS. 3-4 illustrate sequential time-lapse images of a rotating dynamic lighting effect (FIG. 3) and a left-to-right dynamic lighting effect (FIG. 4) using the principles set forth at FIGS. 2A-B.

FIGS. 5A-C illustrates an exemplary embodiment of the invention in which an annular or ring-shaped light-guide has an LED at each of four corners.

FIGS. 5D-E illustrate effective current applied over time (FIG. 5D) to each of the four LEDs of FIGS. 5A-C and time lapse images of the 5A embodiment (FIG. 5E).

FIG. 6A-C are similar to FIGS. 5A-C but for an embodiment with two LEDs per corner.

FIGS. 7-9 illustrate various exemplary implementations of the invention.

FIGS. 10-11 illustrate a further implementation for using an embodiment of the invention to give the dynamic lighting effect of a growing flower.

FIG. 12 illustrates another exemplary embodiment of the invention in which the light-guide is disposed along an edge surface of a slide type mobile phone.

FIG. 13 illustrates an exemplary implementation of the invention disposed in a mobile phone for locating an item bearing an RFID tag.

FIG. 14 illustrates an exemplary implementation of the invention disposed in a mobile phone for a dynamically lighting effect that matches beat and tempo of an audible song file.

FIG. 15 illustrates an exemplary implementation of the invention disposed in each of two mobile phones used to indicate relative direction and distance to one another using the dynamic lighting effect.

FIG. 16 illustrates an exemplary apparatus combining several of the particular embodiments above.

FIG. 17 is a logic flow diagram that illustrates the operation of a method, and a result of execution of computer program instructions embodied on a computer readable memory, in accordance with the exemplary embodiments of this invention.

### DETAILED DESCRIPTION

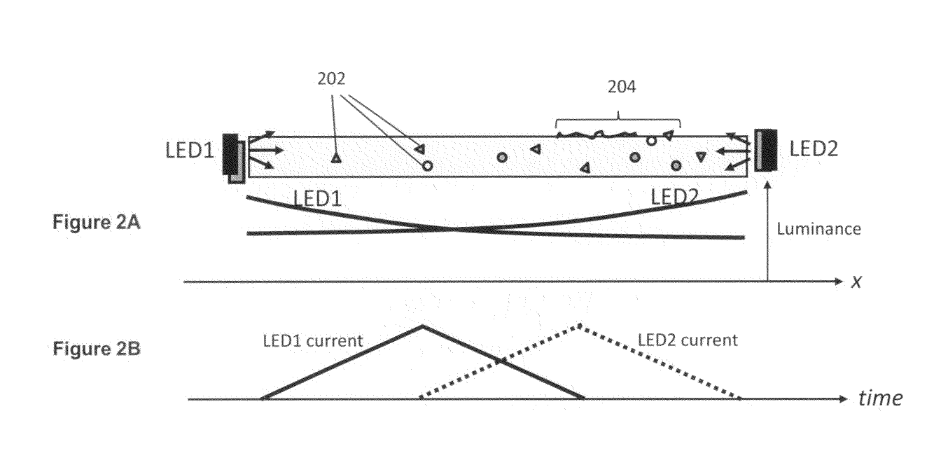

Consider FIGS. 2A-2B. Two LEDs are spaced from one another and each emitting into a light-guide (longitudinally into the light-guide). The light-guide weakly diffuses and scatters light passing through it. The brightness distribution from LED1 along the light-guide longitudinal direction is statically decaying (though in a lossless light-guide brightness is not significantly diminished). From LED2 the brightness distribution is statically increasing. The illusion of light waves in motion is achieved by varying the intensity of those two LED light sources in an extended light-guide. Recall that in the background description, prior art LED sequencing needed to use multiple closely spaced LEDs with an obscuring diffuser to mask the fact that there were in fact multiple discrete light sources operating in cooperation. In FIG. 2A the light-guide can be extended (e.g., two, three or more centimeters), because close spacing is not necessary. This is because a light-guide is used instead of a diffuser, and the light-guide is engineered to scatter the light and to emit the scattered light laterally, from its sides. Temporal control of the LEDs, shown as current variance over time at FIG. 2B, is used with the decay principle of FIG. 2A to generate the dynamic lighting effect.

The light-guide may take many forms, for example a waveguide with translucent sidewalls. It is engineered with light scattering properties to scatter the input LED light by, for example, disposing microstructures along its lateral surface(s), and/or interspersing a material dopant throughout the light-guide. The end result is that the light is scattered, at least along the longitudinal direction which in FIG. 2A is between LED1 and LED2.

Combining the brightness profile of FIG. 2A with the temporal current control of FIG. 2B gives the effect of movement of a “broad bright spot” through the light-guide. It is clear from FIG. 2A that the beams of light from the two LEDs are counter-propagating through the light-guide. The two LEDs are correlated because of the temporal control at FIG. 2B, but unlike the prior art they emit into the longitudinal direction of a light-guide instead of laterally through a diffuser.

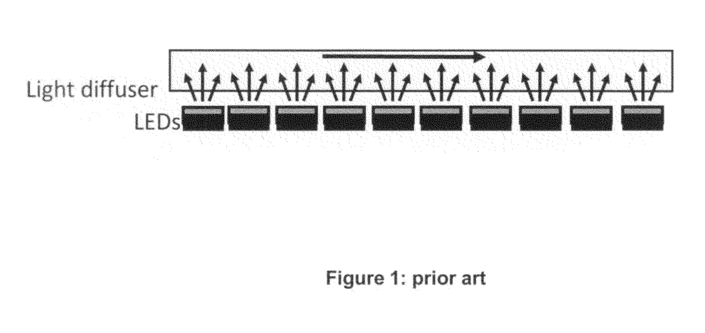

So in general terms, one can describe exemplary embodiments of the invention as generating a dynamic lighting effect by dynamically tuning the light intensity from several correlated LEDs which inject light into extended light-guide structures that have tailored scattering properties. The dynamically tuned light intensities are emitted longitudinally into a light-guide structure for lateral scattering from it. The viewer sees light emanating from the lateral surfaces of the light-guide(s). Because the light-guide can be extended as noted above, close spacing of the light sources is not critical as in the prior art and so embodiments of this invention require less light sources than a similarly smooth moving result made according to prior art approaches. There are no moving parts, and there is no need for a thick diffuser as noted with respect to FIG. 1.

The longitudinal direction at FIG. 2A runs between LED1 and LED2. Using Cartesian coordinates, the other axes of the light-guide are then height and width, and in an embodiment the height and width of the light-guide are on the same order and the length (longitudinal measure) of the light-guide segment between two adjacent LEDs emitting counter-propagating beams is much greater than both height and width (e.g., at least 10 times greater, and in the embodiment constructed and tested by the inventors more than 20 times greater). The lateral direction through which the scattered and emitted light is seen by an observer is perpendicular to the longitudinal axis of that light-guide segment. This is quite different from prior art diffusers as shown by example at FIG. 1.

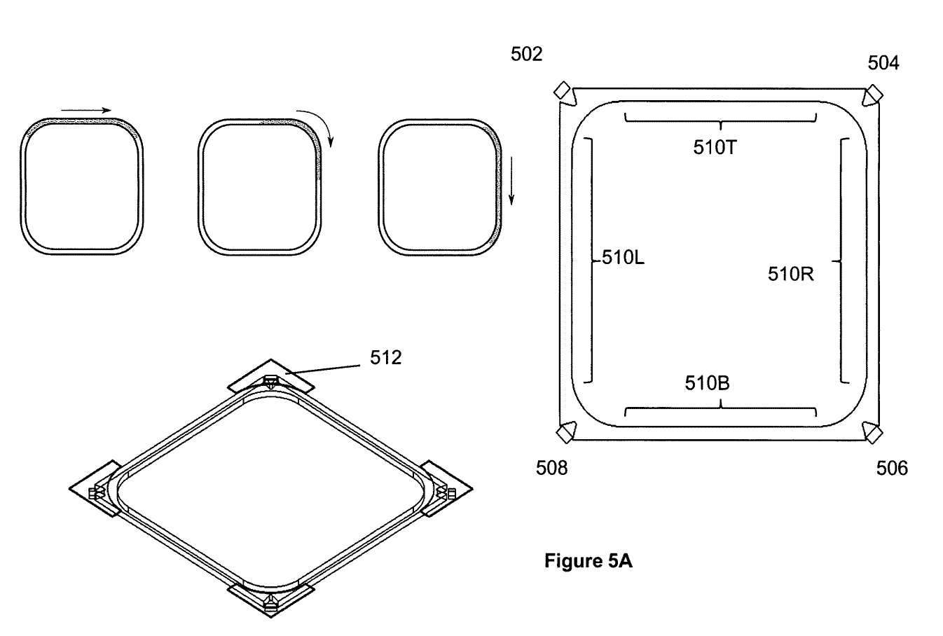

By manipulating temporal control of current to the different LEDs in correlation with one another, the arrangement of FIG. 2A will result in the appearance of a bright spot moving left to right as seen in the seven time-lapse images at FIG. 4. At the topmost image there is no power to LED2 on the right and a gradually increasing current applied to LED1 at the left. Maximum current is applied to LED1 at the third image from the top while a minimal current is being applied to LED2. As time continues through the next three images, current to LED1 decreases and current to LED2 increases, until the final image at the bottom in which there is no current to LED1 and a small and diminishing current applied to LED2.

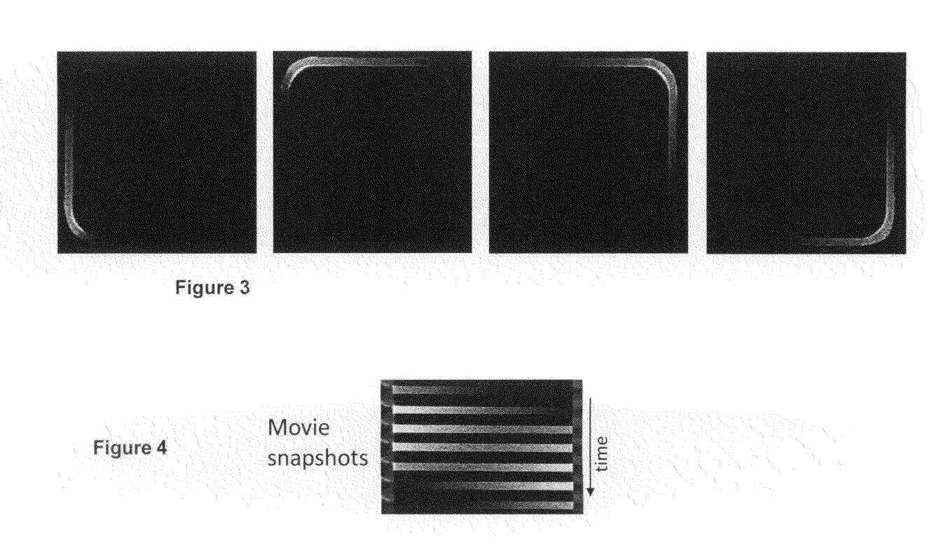

FIG. 3 illustrates the same principle with an annular or looped light-guide having an LED at each of the corners. The dynamic lighting effect there is one rotation about the loop beginning at the lower left corner at the left of FIG. 3 and moving clockwise through the lower right corner at the right of FIG. 3.

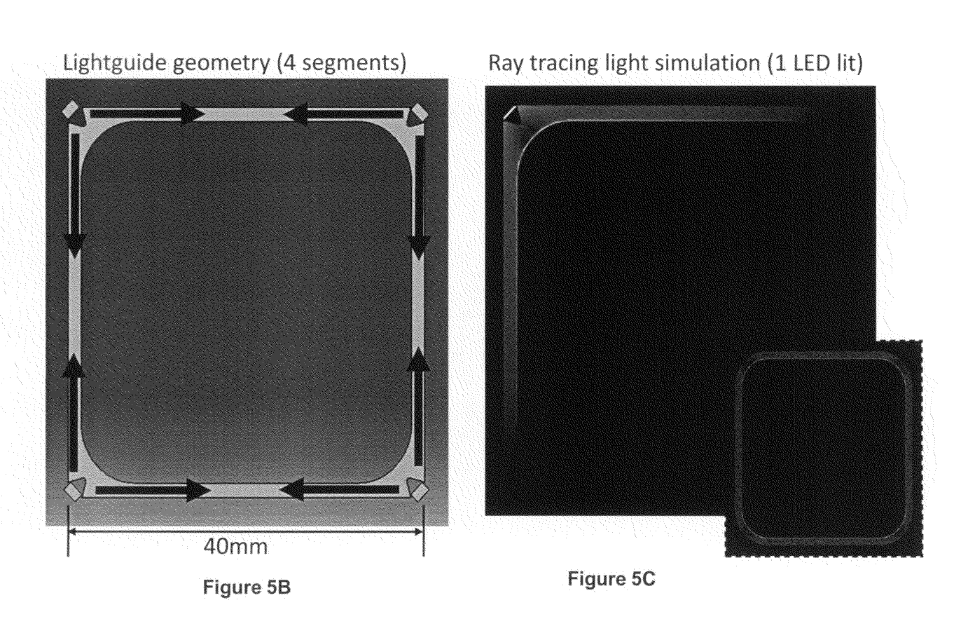

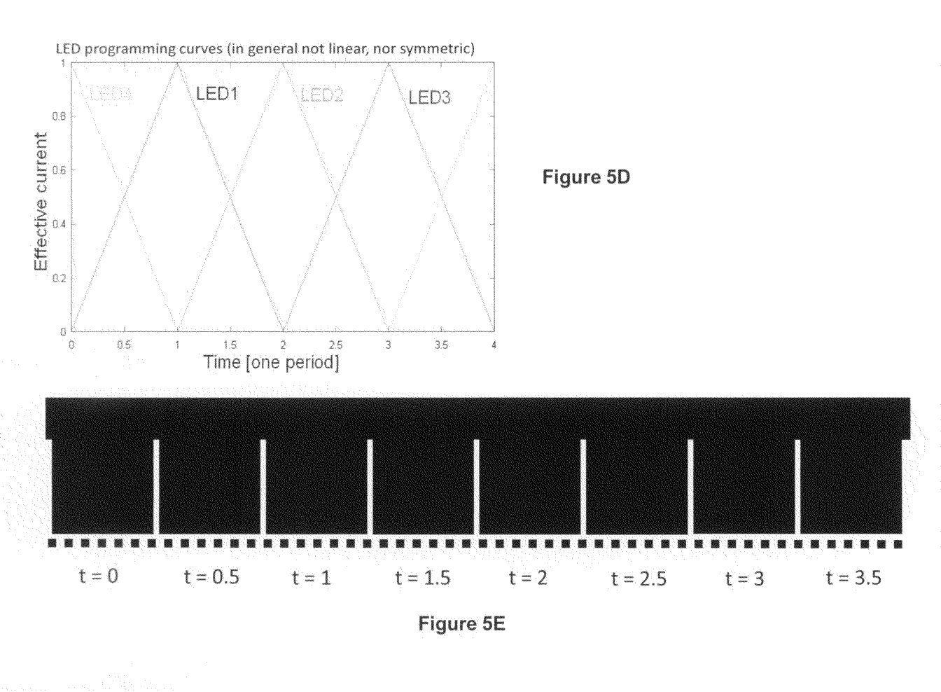

Such an annular light-guide arrangement is shown more particularly at FIG. 5A. The light-guide is shown with its four distinct sides 510T top, 510R right, 510B bottom, and 510L left. There is an LED 502, 504, 506, 508 at each corner of the rectilinear light-guide. The perspective view of FIG. 5A shows masking foil 512 over the LEDs themselves to block light that might otherwise leak directly from the sources; the dynamic effect is most pronounced if the only light seen by the observer is emitted from the lateral sides of the light-guide itself. The time lapse drawings at FIG. 5A show the brightness apparently moving from the top 510T of the light-guide to the corner where LED 504 is disposed then to the right side 510R of the light-guide.

Relative size for one particular embodiment is shown at FIG. 5B. Note that there is a span of 40 mm between adjacent LEDs; this is seen to be well beyond what the prior art sequencing LEDs with overlying diffuser can achieve while still producing a dynamic movement effect. The tested embodiments also exhibited a better smoothness of apparent motion than prior art diffuser-style LED arrangements. The LEDs at each corner emit longitudinally into both adjacent sides of the annular light-guide. FIG. 5C illustrates illumination of the light-guide with one LED lit. The inset shows the same arrangement with all four LEDs at the corners lit, but there is a top masking sheet overlying the light-guide/LED combination so as to prevent light leakage outside the light-guide from the LEDs. The top sheet serves a function similar to the foil 512 shown at FIG. 5A.

The embodiment of FIG. 5 was constructed by the inventors for testing. The light-guide is doped PMMA measuring 4 cm by 4 cm, which is a weakly diffusing optical material. The light-guide thickness was 1 mm and its width was 1.5 mm. The LEDs were controlled by a driver board using pulse width modulation (PWM), and for simplicity of testing initially only a linear current ramp-up and ramp-down were used. PMMA represents poly-methyl methacrylate as in the tested embodiment of FIG. 5A, or sometimes it is used to refer to poly-methyl 2-methylpropenoate. Any of various transparent plastics can be used as a light-guide, particularly translucent synthetic polymers. The doping increases the scattering function of the light-guide. Doped glass can also be used as a light-guide.

Preferably, the light-guide is made of an optically transparent and isotropic material. These include, as non-limiting examples: optical polymers and glasses, acrylic glass (of which PMMA is one example), polycarbonate (PC), silicone rubber, thermoplastic polyurethane (TPU), and silica (glass). Exterior surfaces of the light-guide may be coated with another optical material, which should be chosen such that the refractive index of the light-guide/core material is still large enough to allow for efficient propagation of the light beams. The tested light-guide interfaced directly to air, with no external surface coating.

The light-guide can be engineered for different types of scattering according to the exemplary embodiments. For volume scattering, dopants dispersed through the light-guide scatter light within the light-guide itself, and some of this scattering is directed toward the observer. Volume scattering may be based on refraction, reflection, diffraction, or any combination of them. In the tested embodiment, hollow glass spheres were used as a dopant within the PMMA volume for refractive scattering. Other exemplary volume scattering dopants include air voids, or more generally particles/beads of an optical material having a different refractive index than the light-guide material itself. Exemplary size of dopant particles should be between about 10-100 micrometers or less, so that the individual dopant particles are smaller than can be seen with an un-aided human eye. While pigments can be used as a scattering dopant, the increased light loss through absorption is seen to render them less ideal than more transparent alternatives. Another example of a volume scattering mechanism is air voids or reflection planes dispersed within the material of the light-guide. Air voids may be formed for example by a focused laser beam ‘micro-explosion’ technique which creates air voids near the exterior surface of the light-guide material. In various embodiments these nodes which cause the volume scattering may be ordered or disordered.

Another type of scattering is surface scattering. In this technique the exterior surface of the light-guide is engineered to scatter light at the surface by, for example, small surface texturing or small engineered structures such as micro-prism arrays or gratings. The surface scattering mechanism may be applied directly to the material of the light-guide as in surface texturing/abrasions and surface gratings, or the surface scattering mechanism may be imposed via a coating on the external surface of it. An example of the latter is a patterned ink coating (e.g., white ink). The surface scattering mechanism may be considered as outcoupling structures which re-direct light to a different direction after reflection/refraction from those structures. Volume scattering and surface scattering/outcoupling structures may be used individually or in combination in particular embodiments of the invention. Outcoupling structures that re-direct the light may also be dispersed within the material of the light-guide. At FIG. 2A, volume scattering nodes or outcoupling structures disposed within the material of the light-guide are shown as 202, and surface scattering or surface disposed outcoupling structures are shown as 204.

While power consumption in a commercial embodiment of the invention is anticipated to be on the order of 10-20 milliamps at 3 volts, FIG. 5D shows an effective current profile for the four-LED embodiment of FIG. 5A, where max current is 1.0 on the FIG. 5D effective current scale. At its simplest, the current versus time profile is sawtooth and symmetric as in FIG. 5D, but non-linear and/or asymmetric curves enable more interesting and widely varying dynamic lighting effects. FIG. 5E shows time-lapse images at each 0.5 seconds using the current profile of FIG. 5D. Assuming correspondence of LED4, LED1, LED2 and LED3 of FIGS. 5D-E with the respective positions 508, 502, 504 and 506 of FIG. 5A, then the center of brightness at the various times in FIGS. 5D-E moves from the lower left corner at t=0 clockwise about the light-guide to the center of the bottom section of the light-guide 510B at t=3.5.

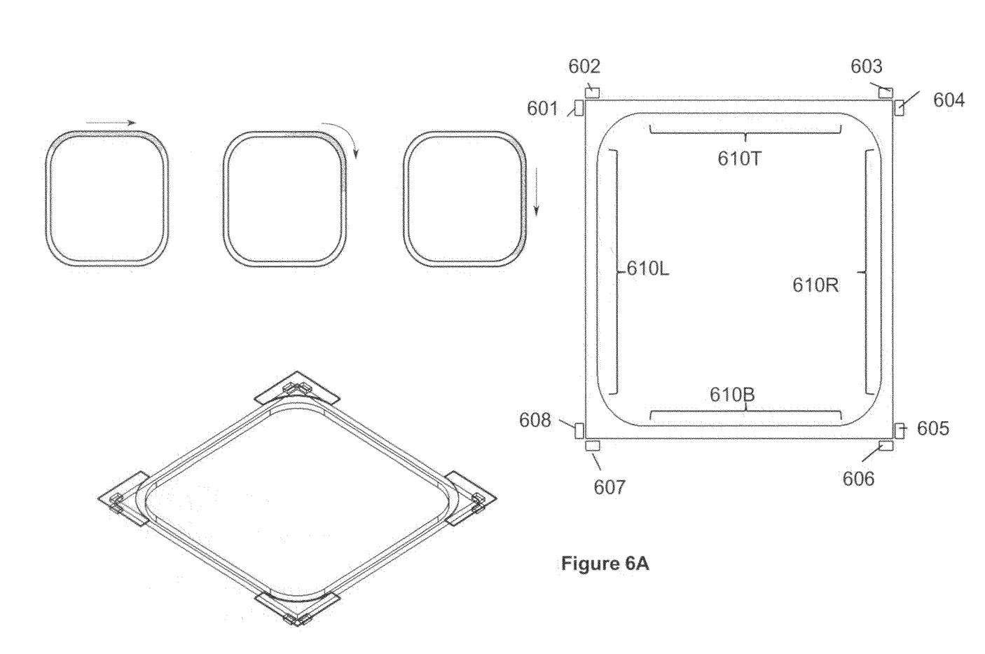

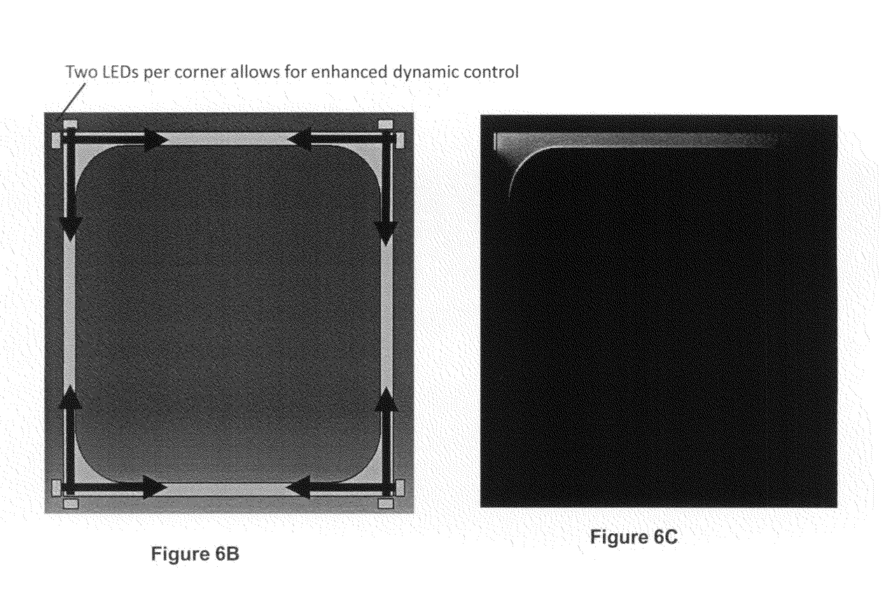

FIG. 6A modifies FIG. 5A in that there are two LEDs at each corner of the light-guide. With further reference to FIG. 6B, emitting in a forward or clockwise direction are the following: LED 601 which emits only into section 601T of the light-guide; LED 603 which emits only into section 601R of the light-guide; LED 605 which emits only into section 601B of the light-guide; and LED 607 which emits only into section 601L of the light-guide. Emitting in a reverse or counter-clockwise direction are the following: LED 602 which emits only into section 601L of the light-guide; LED 604 which emits only into section 601T of the light-guide; LED 606 which emits only into section 601R of the light-guide; and LED 608 which emits only into section 601 B of the light-guide. Note that each pair of LEDs emitting into the same light-guide section emit counter-propagating beams. The illustration of these counter propagating beams at FIG. 6B makes clear that there are still counter-propagating beams in the four-LED embodiment of FIG. 5B, since each LED in the FIG. 5B embodiment emits in two adjacent sections rather than only in one section as in FIG. 6B. To contrast against FIG. 5C, FIG. 6C also shows a single LED powered on, which in this case is LED 601. Clearly there is emission only in section 610T of the light-guide and any light in section 610L is simply leakage. This eight LED embodiment gives greater control over the dynamic lighting effect, without disposing any LED appreciably closer to its counter-propagating neighbor.

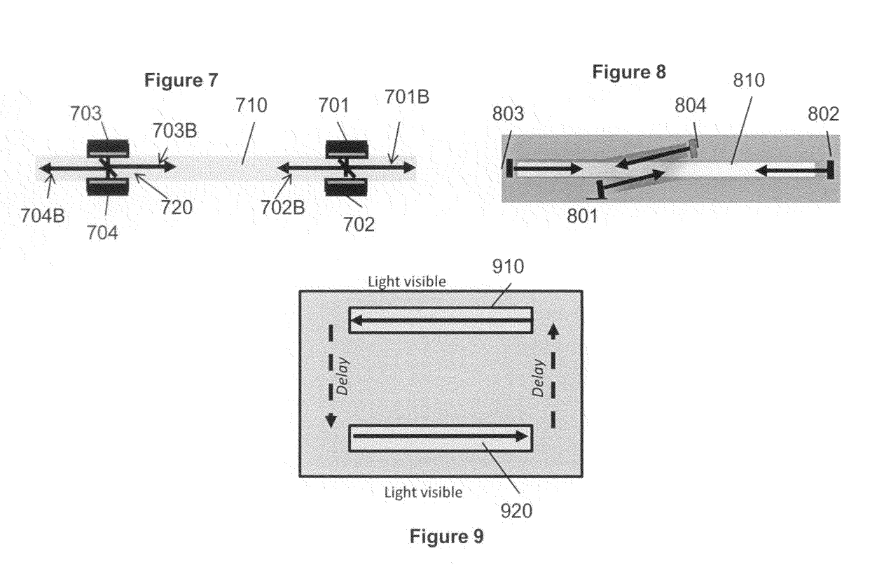

FIGS. 7-9 illustrate various other embodiments. Before engaging those figures it is prudent to note that the various embodiments presented herein can be used to simulate a moving dark spot (for example, by inverting the current profile); they can be used to mimic a sweeping light or dark effect (side to side, top to bottom, diagonally); and/or they can be used to mimic a bouncing light or dark movement.

At FIG. 7 is an embodiment in which the orientation of the LEDs themselves is not along the longitudinal axis of the light-guide, but perpendicular to it. That is to say, the optical axis of the LED is roughly perpendicular to the optical axis of the nearest section of the light-guide. In the FIG. 7 embodiment, there are reflective interfaces 720 within the light-guide 710 itself which re-direct the beams emitted from the various LEDs to the longitudinal direction/axis of the light-guide, or at least that section of the light guide in which the reflector is disposed (since the light-guide itself can bend quite severely as shown at FIG. 5A). Specifically at FIG. 7, the beam from LED 701 is directed by a reflective interface as 701B, the beam from LED 702 is directed by the reflective interface 720 as beam 702B, and similar for LED 703/beam 703B as well as LED 704/beam 704B.

The reflector 720/reflecting interface is one example of what can generally be termed as an optical coupler, and more complex optical couplers can of course be disposed within the light-guide. In various embodiments, the reflector may be embodied as an air gap between different segments of the light-guide material, or as a sheet of reflecting material within or between segments of light-guide material, or as an interface between two different light-guide materials having different refractive indices. Any of these operate to allow light to be reflected inside the polished light-guide material.

FIG. 8 illustrates four LEDs emitting longitudinally into the light-guide 810, but two of them 801 and 804 emit a bit off-axis while the other two 802 and 803 emit along the axis. Optical couplers/reflectors are not needed at obtuse angles such as those shown for 801 and 804, since the beams can propagate through angles less than the critical (maximum) angle for total internal reflection (TIR) without too much loss of intensity. That critical angle depends on the refractive index of the material of the light-guide; for example, the critical angle for PMMA is about 42 degrees.

Note that at FIG. 5A the LEDs 502, 504, 506, 508 emit at 45 degrees to either of their respective light-guide segment 510T, 510R, 510B, 510L. Angular cutouts shown between those LEDs and the light-guide itself use refraction to re-direct the light from those four LEDs along the longitudinal pathways. While there is some light loss with this arrangement, the surfaces of these cutouts facing the LEDs may be considered as optical couplers since they are not perpendicular to the optical axis of the corresponding LED. Similar cutouts/couplers are notably absent from the eight-LED embodiment at FIG. 6A since the LED optical axes are already aligned with the longitudinal axes of the relevant light-guide segments. At FIG. 7, the exterior (longitudinal) surface of the light-guide is perpendicular to the optical axis of the LED but the optical coupler 720 is not. In prior art LED/diffuser arrangements as seen at FIG. 1, the surface of the diffuser is perpendicular to the LEDs and so the diffuser simply diffuses light emitted by the LEDs laterally and omni-directionally though the diffuser body. Such diffusion is not re-directing light as is the case with the couplers 720 of FIG. 7.

FIG. 9 illustrates an embodiment to achieve a light-tunnel effect. FIG. 9 has two instances of the linear light-guide shown at FIG. 4A. There is an LED at each end of light-guide 910 and also at each end of light-guide 920, and those two light guides are not optically interfaced to one another. They are controlled in timing so that light moves right to left along light-guide 910, appears to move beyond the end of that light-guide 910, and after some delay the bright spot moves from left to right along the other light-guide 920. After a delay again the process repeats, so the cycle appears to be a constantly moving bright spot for which the two light-guides 910, 920 are simply windows to an overall loop which in fact does not exist. By example, such light tunnels may be disposed alongside a mobile phone display screen for the dynamic lighting effect of a light pulse moving about a loop within the phone and only visible when passing through the light tunnels themselves.

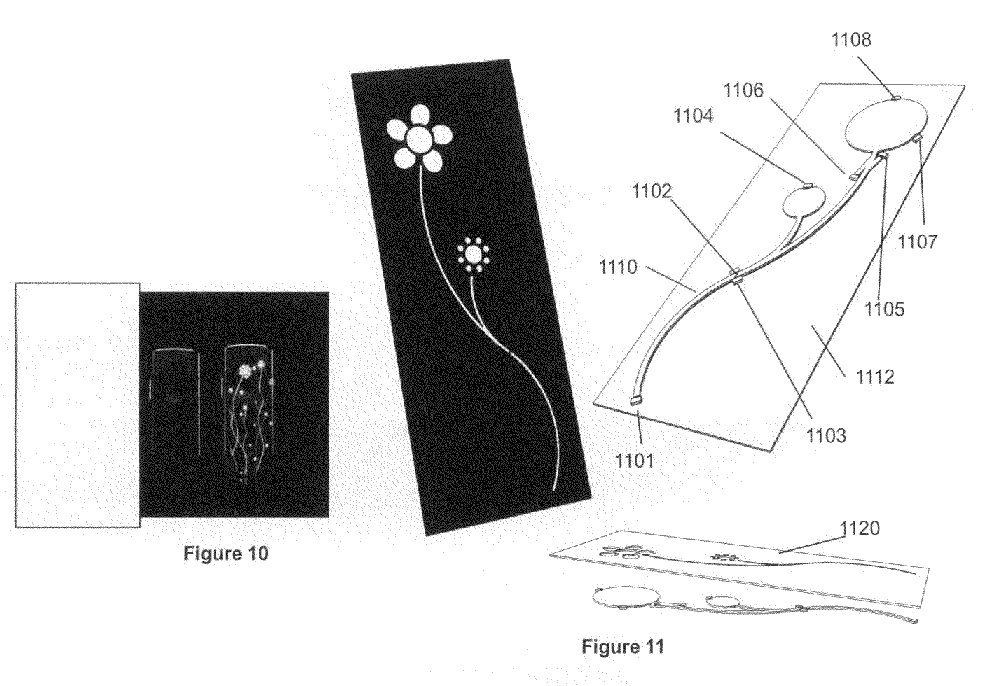

FIGS. 10-11 illustrates a particularly interesting embodiment that demonstrates the versatility of a combination light source/light-guide apparatus according to these teachings. At FIG. 10 are two images: a mobile device with no lighting active, and the same mobile device with a few flowers and stems fully illuminated. The effect is not simply to turn on or off the illumination of the flowers and stems, but to do so in a manner that simulates the flowers actually growing. One flower is shown in the detailed portion at the center of FIG. 11. There is an overlayer 1120 with the cutout of the flower petals since those are not shown to grow distinct from the flower head. The substrate 1112 has disposed on it the light-guide 1110 and a series of strategically placed LEDs. At the flowers themselves the light-guide expands to a large circle which spans the flower head and the petals defined by the cutout 1120.

To begin the growing flower, the LEDs are lit up with increasing current in the following order: base of stem LED 1101, then downward directed LED 1102, then upward directed LED 1103 (note the reflector between them to direct the respective beams), then first flower LED 1104. The illusion that the stem then continues to grow beyond the first flower continues with LED 1105 which is downward directed and counter-propagates against LED 1103, then upward directed LED 1106, and finally large flower LEDs 1107 and 1108, which may operate simultaneously rather than staggered in time for the larger lateral area of the larger flower. Of course, variations might increase the realism, such as by applying a gradually increasing current to both small flower LED 1104 and to downward directed stem LD 1105 at about the same time. Multiple such flowers can be disposed along the major surface of the mobile device shown at the left of FIG. 11 to give the dynamic lighting effect of a growing garden.

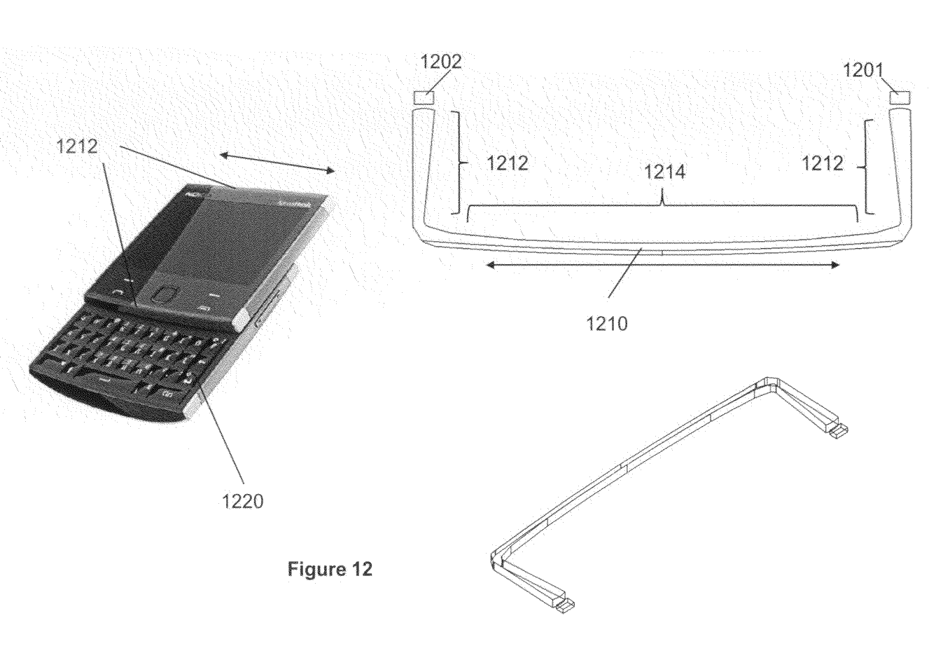

FIG. 12 illustrates another implementation on a mobile device 1220, in which there are two identical embodiments of the light-guide, each disposed along opposed exterior edges of the device housing and the apparent motion of the light is along the arrow indicated there. The top view and perspective view of the dynamic lighting effect component of the device show one of those identical embodiments, in which there are two LEDs 1201, 1202 at opposed ends of the light-guide 1210. The light-guide 1210 can be considered to have two in-coupling arms 1212 that interface to one another through a single out-coupling arm 1214. When disposed in the device, the in-coupling arms 1212 are hidden from view and light is emitted only from the out-coupling arm 1214 which is disposed along the lateral (shorter) edge of the device 1210. The LEDs 1201, 1202 may be different color so a viewer can differentiate right from left, but the different color LEDs in that example still counter-propagate and so the dynamic effect would appear as a light pulse that changes color as it moves.

The two out-coupling arms 1212 on the mobile phone 1220 may be considered as illuminated accent bands, in which the LEDs that illuminate them are controlled by a controller so as to highlight that the phone's music player mode is active (e.g., one or more effects such as bouncing light, a twisting light, or a looping light), and possibly also to express music visually through dynamically moving light effects that are synchronized to the music being played (e.g., effects such as visualizing an equalizer or VU bar meter or moving to the music beat).

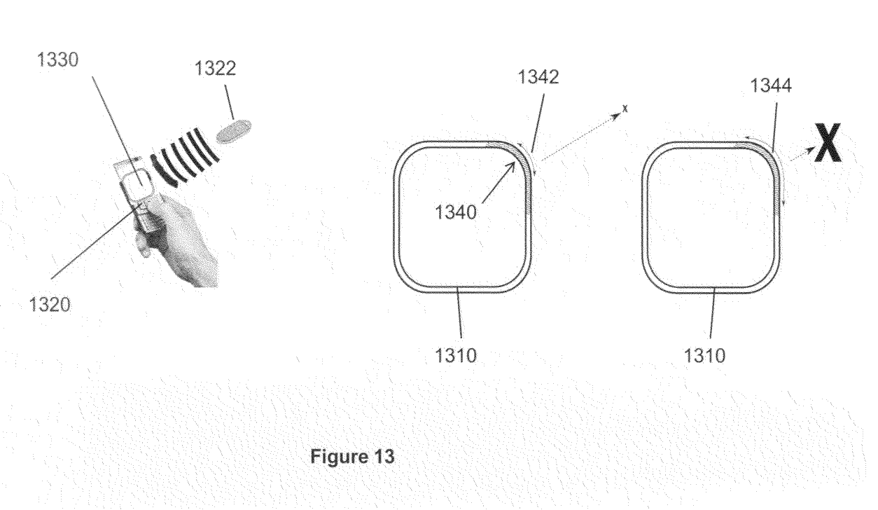

FIG. 13 illustrates a use of an embodiment of the combination light source/light-guide apparatus for a navigation function: light assisted navigation. As illustrated, the apparatus is disposed so that the light-guide 1310 is visible about a loop, which may for example surround a display screen 1330 of a mobile device 1320. In this exemplary navigation embodiment the dynamic lighting effect operates as a directional pointer to show relative direction to a target. The user does not need to read a map, but instead simply follows the direction indicated by the brightest portion of the loop. Other portions of the display screen 1330 can be darkened to conserve power in such a navigation application. The navigation option has many implementation options. In one embodiment, the navigation is to a radio-frequency identification (RFID) tag 1322, such as for example one that may be embedded in a lost wallet or implanted in a lost pet or affixed to the lost pet's collar, and where the mobile user device knows/locally stores the RFID of the missing wallet or pet. In this embodiment the display screen 1330 can also give a name for the tagged item. In another implementation, the navigation is to a mapped location stored on an internal memory of the device, where the current position of the device is updated via GPS or triangulation for example. In this embodiment the display screen can also show a birds-eye or street-view map of the mobile phone's current position or of the target's position or both. In another embodiment the navigation is to another mobile terminal, in which case both devices exchange their current location information to enable proper navigation between those two potentially moving objects. In this embodiment the display screen may show the friend name assigned by the user of one device to the device to which the navigation points. The display screen 1330 may also include a near/far indicator such as a vertical bar, with lighting indicating relative distance to the target in any of the above embodiments, and the near/far indicator may itself be another implementation of the LED/light-guide apparatus.

FIG. 13 additionally illustrates an embodiment using a looped light-guide 1310 in which the distance to the target “x” can be indicated by the speed of the dynamic lighting effect (speed of apparent motion of the light). For example, the center of brightness 1340 about the light-guide 1310 can be made to move back and forth (oscillate) along a subset of the light-guide, such that a smaller oscillation distance 1342 indicates the target is farther and a larger oscillation distance 1344 indicates the target is nearer.

Frequency of the oscillation may be used to the same end: a faster oscillation indicates the target is near and a slower oscillation indicates the target is far. Of course, the oscillation distance and frequency may be combined in an embodiment, the exemplary conventions to indicate near/far above may be reversed in other embodiments, and/or either oscillation distance or frequency may be used to indicate uncertainty in the direction to the target. Alternatively or additionally, the navigation function can be used as an aid to the hearing impaired, such as for indicating relative direction to a speaker whose position is sensed via a directional microphone in the device or other sensing means.

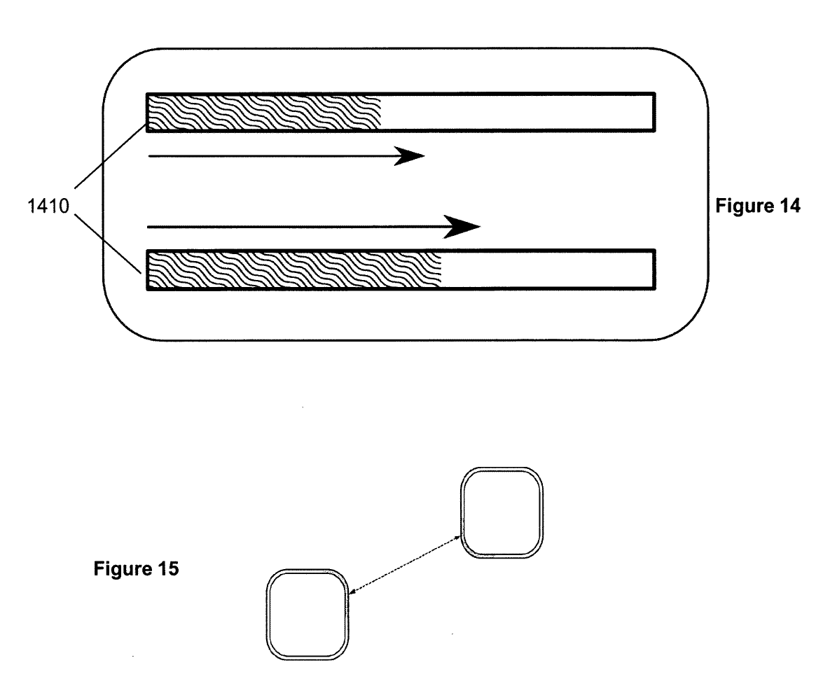

An embodiment of the combination light source/light-guide apparatus can also be used as a visual companion to music as shown by example at FIG. 14. Any of various dispositions of the light-guide may be used to emit light in synchronization with a musical beat or rhythm being played by the host device (e.g., a mobile device with music playing capabilities, for example), where dynamic movement and optionally also color changes are displayed synchronous with the music and controlled electronically by the beat/rhythm. More functionally, one or more light-guides 1410 may be disposed to indicate volume in each stereo channel for example, with the extent of the brightness along the visible portion of the light-guide indicative of sound level.

FIG. 15 illustrates light-guides in two different mobile devices to detail exemplary gaming and social interaction implementations. In one implementation when the controller for the LEDs interfaces to an accelerometer which senses movement, the LEDs can be controlled to create a visual illusion of light as a viscous and inert medium (e.g., a light droplet) which reacts to movement of the host device (e.g., mobile device). Shaking or spinning the device harder or faster results in the light seeming to move faster about the ring. In one particular embodiment the light droplet can be a simple game, where the user attempts to follow its movements in the plane, or in a three dimensional geometry or structure simulating a game board. The speed of the moving light increases with the difficulty level.

Another game implementation uses the light in the ring as a pointer, so that for example whomever is in the direction pointed by the bright spot once the light stops moving about the ring is selected from the group of friends to engage in some action (e.g., to buy the next round of drinks, to accept a dare, etc.)

Another embodiment for the arrangement of FIG. 15 is the illusion of light attraction. This is similar to the navigation embodiment at FIG. 13 in which two phones each having an embodiment of the invention (e.g., as a ring light-guide) are configured such that the light within the respective rings ‘point’ to one another. This may be considered as a ‘friend finder’ implementation, where the navigation function is dynamic between two phones and the two light rings navigate toward each other. If in fact no ‘friend’ or cooperating device is nearby (no ‘friend’s device is both enabled for this function and turned on), then the light may be simulated to move about the ring randomly.

The LED controller may interface with a touch sensitive surface of the host device so that the light appears to interact with the user's touch. For example, the light-guide ring may surround a device touch sensitive display, and as the user moves his/her finger across the touch sensitive display, the light appears to move in the ring to mimic the direction of the user's finger movement (e.g., left to right, diagonal, etc.). This gives the illusion of transferring energy to the moving light pulse.

In another embodiment, the light movement and/or color can be adapted to visually represent the ‘mood’ of the user, in which the mood may be dependent on the user's touch (e.g., where the LED control depends on inputs from a touch-sensitive surface similar to that discussed above) and/or on how gently or forcefully the host device is moved around (e.g., where the LED control depends from an accelerometer input) and/or on temperature sensed from the user holding the host device (e.g., where there is some temperature sensor on the host device adapted to sense local temperature changes at its exterior surface).

Of course, in any of the above embodiments there may be user settings by which a user can personalize certain aspects of the dynamic lighting effects, such as for example setting parameters for the viscosity of the light droplet, color selection if multiple different color LEDs are in the embodiment, whether mood-visualizing is on or off, and the like.

The apparatus which displays the illusion of light movement may be controlled by various other types of control inputs that govern how the light movement displays. As examples: the speed and direction of light motion can indicate signal strength as when the control input is radio signal strength of a wireless radio; it can be used to visually indicate an amount of online friends as when the control input is coupled to a common Internet portal; and/or it can be used to visually indicate a number of missed calls or unread messages when the control input is coupled to a phone memory storing that data. Further, the light-guide may be implemented as a download bar, in which light appears to bounce back and forth in the light-guide to indicate status of downloading (e.g. music). By example, the apparent speed of the light motion can indicate data transfer rate. In another example the light-guide visualizes a timer, in which a countdown function is displayed as lights fading from top to bottom of the guide (similar in visual effect to an hour-glass). The LEDs may be controlled by an input from a battery monitor so that the light-guide visualizes a charge-cycle. When charging the phone, the light-guide (which may for example be disposed around the perimeter of the phone) appears to visually fill as charge accumulates in the battery, indicating visually how full the battery is at any given instant and also when battery re-charging is complete.

Various other implementations may be primarily for aesthetic decoration rather than primarily for a metering or gaming function. Of course, there may still be a simple practical function behind the decorative effect, such as at FIG. 11 where the flower garden is not visible when the device is idle but is illuminated in a dynamically growing manner when the device goes to an active state such as for an incoming call. Other examples of a decorative effect include simply a smoothly traveling light pulse to visually highlight housing edges or display borders of the host device, which aid in locating it when ambient light is dim. Other implementations use an interactive/adaptive decoration in which the controller for the LEDs interfaces with one or more sensors as noted above (e.g., accelerometer, phototransistor or other ambient light sensor (ALS) arrangement, thermometer, microphone, camera). Further exemplary implementations for the sensor controlled lighting effect include where the light motion generally reacts to its ambient environment to show movement, temperature, ambient light, and/or sound. Smoother color transitions can be made by disposing different color LEDs with counter-propagating beams such that their different color beams overlap to a large extent within the light-guide.

It can be seen from the examples above that the combination light sources/light-guide apparatus detailed herein improves on existing illumination technology platforms of LEDs and polymer light-guides. More simple implementations require few components but the combination is quite versatile for more complex effects such as FIG. 11 illustrates. There is some limit to the variations that can be achieved in that a light pulse generally travels through an entire light-guide segment that runs between LEDs, so a pulse cannot be actively controlled to disappear midway between LEDs. This is not seen to be a major limitation though. Material costs and power consumption are relatively low and so these are no bar to commercial implementation. Generally the light-guide can be implemented in a thickness of 0.5 mm or less, and so it is particularly well adapted for use in mobile devices which are generally crowded with radio and other feature components. The components of the light-guide/light source apparatus are robust and mechanically stable, so easy to incorporate into a wide variety of host devices apart from mobile phones as in the examples above.

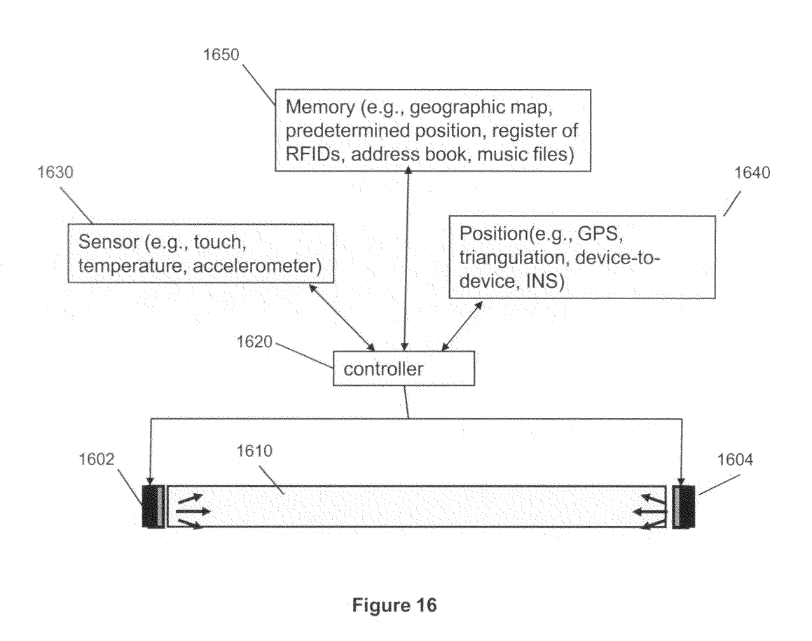

FIG. 16 illustrates an exemplary embodiment which combines certain of the examples detailed with more particularity above. The dynamic lighting effect apparatus has a plurality of visible light sources, shown at FIG. 16 as two light emitting diodes LEDs 1602, 1604. Any controllable source of visible light will suffice, such as an incandescent bulb, but LEDs are favored for their low cost, low power, small size and mechanical robustness. Other embodiments can use non-visible light sources, such as for example ultraviolet light sources with fluorescent scattering in the light-guide structure to produce a visible light result. Also at FIG. 16 there is a light-guide structure 1610 disposed to longitudinally propagate light emitted by the LEDs 1602, 1604 through the light-guide (or at least a portion of it, as with the ring-type embodiments above). The light-guide structure is configured to scatter and/or re-direct the emitted light and to output the scattered and/or re-directed light laterally. Also at FIG. 16 is shown a controller 1620, which is configured to dynamically correlate the light emitted from the plurality of visible light sources and to dynamically tune intensity of the light emitted from the plurality of visible light sources.

The arrows from controller 1620 to LEDs 1602, 1604 are control inputs, which in an embodiment are used to meter current applied to the LEDs. This metered current may change linearly with time, or non-linearly with time, and need not be symmetrically applied to the LEDs.

In an embodiment the light-guide structure is made of a translucent polymer, and it is configured to scatter the emitted and/or re-directed light by at least one of volume scattering nodes (e.g., a dopant such as particles or air voids dispersed through a volume of the light-guide) and outcoupling structures dispersed about exterior surfaces of the light-guide (e.g., surface texturing, abrasion, micro-optical structures such as gratings, and the like).

In the embodiment of FIG. 16, at least two of the plurality of light sources may be disposed so as to emit beams that counter-propagate relative to one another within the portion of the light-guide structure. The light sources may be visible light sources.

As detailed with respect to FIG. 7, in an embodiment of FIG. 16 at least one of the plurality of light sources is disposed to emit light in a first direction and the light guide structure comprises an optical coupling element for re-directing the light emitted in the first direction to a second direction which is the longitudinal direction of the light-guide structure.

As detailed with respect to FIGS. 5-6, in an embodiment of FIG. 16 the light guide structure is arranged to form a closed loop and there are at least four visible light sources spaced about the loop.

In one particular embodiment according to FIG. 16, the controller 1620 has an input from at least one sensor 1630 of the host device, and the controller is configured to dynamically correlate the light emitted and to dynamically tune intensity of the light emitted in dependence on the at least one sensor input. By example only, such a sensor may be a touch sensitive sensor, a temperature sensor, and/or one or more accelerometers.

In another particular embodiment according to FIG. 16, the controller 1620 has a dynamically updated current position input from another device or component 1640 of the host device, and the controller is configured to dynamically correlate the light emitted and to dynamically tune intensity of the light emitted in dependence on the current position input. By example only, such a device which provides the dynamically updated current position of the host device as input can be a global positioning system GPS receiver, a radio receiver or transceiver from which position can be triangulated from two or more base stations, a radio transceiver that can fix position of the host device using device-to-device communications (e.g., independent of base stations), or an inertial navigation system such as an arrangement of ring laser gyros which can sense and update its position inertialy.

In another particular embodiment according to FIG. 16, the controller 1620 has a memory input from a local memory 1650 of the host device, and the controller is configured to dynamically correlate the light emitted and to dynamically tune intensity of the light emitted in dependence on the memory input. By example only, such memory input may be from a geographic map, or a pre-stored geographic position, a register such as a list of stored RFIDs, an address book so as to visually display how many ‘friends’ are near or online, and a digital music file such as for music synchronization.

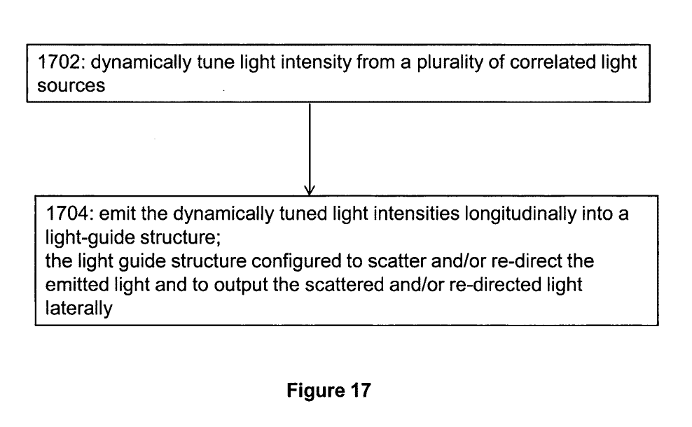

Note also that in an embodiment of the invention there is a memory 1650 which stores a program of machine readable instructions which when executed by a controller 1620 cause the dynamic lighting effect described herein, and particularly as described below with reference to FIG. 17. Exemplary embodiments of this invention may be implemented at least in part by computer software executable by the controller 1620 of the host device or a separate dedicated controller 1620, or by hardware, or by a combination of software and hardware (and firmware).

The computer readable memory 1650 may be of any type suitable to the local technical environment and may be implemented using any suitable data storage technology, such as semiconductor based memory devices, flash memory, magnetic memory devices and systems, optical memory devices and systems, fixed memory and removable memory. The controller 1620 may be of any type suitable to the local technical environment, and may include one or more of general purpose computers, special purpose computers, microprocessors, digital processors (DPs) and processors based on a multicore processor architecture, as non-limiting examples.

In general, embodiments of the host device vary quite widely and need not be portable or even small. Specific embodiments detailed above refer to a mobile host device, which may be implemented as, but are not limited to, cellular telephones, personal digital assistants (PDAs) having with or without wireless communication capabilities, portable computers, image capture devices such as digital cameras, gaming devices, music storage and playback appliances, Internet appliances permitting Internet access and browsing, as well as portable units or terminals that incorporate combinations of such functions. Any of these may or may not have a wireless communication capability, as only certain exemplary but non-limiting features described above rely on a wireless interface in the host device. Other embodiments that are not portable include a home stereo system, a club dance floor or wall, a stand-alone wall-mount or desktop digital picture device, to name a few.

FIG. 17 is a logic flow diagram that illustrates the operation of a method, and a result of execution of computer program instructions, in accordance with the exemplary embodiments of this invention. In accordance with these exemplary embodiments a method performs, at block 1702, a step of dynamically tuning light intensity from a plurality of correlated light sources, which in a particular embodiment are visible light sources. At block 1704 there is the step of emitting the dynamically tuned light intensities longitudinally into a light-guide structure which is configured to scatter and/or re-direct the emitted light and to output the scattered and/or re-directed light laterally.

In a particular embodiment of the method and computer program of FIG. 17, dynamically tuning comprises controlling a current applied to at least one of the light sources so the applied current varies non-linearly with time.

In a further particular embodiment of the method and computer program of FIG. 17, the light-guide structure is configured to scatter and/or re-direct the emitted light by at least one of: volume scattering nodes dispersed through the material of the light-guide (e.g., dopants like particles or air voids); and outcoupling structures dispersed about exterior surfaces of the light-guide (e.g., surface texturing, abrasion, gratings, etc.).

In another particular embodiment of the method and computer program of FIG. 17, emitting the dynamically tuned light intensities comprises emitting beams from at least two of the plurality of light sources longitudinally into the light-guide so that the beams counter-propagate through at least a section of the light-guide.

Further variations to the method and computer program are detailed above with respect to FIG. 16, and in the preceding specific but non-limiting examples and implementations.

The various blocks shown in FIG. 17 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the controller for exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1. A method, comprising:
dynamically tuning light intensity from a plurality of correlated light sources; and
emitting the dynamically tuned light intensities longitudinally into a light-guide structure which is configured to scatter and/or redirect the emitted light and to output the scattered and/or redirected light laterally.

2. The method according to claim 1, wherein dynamically tuning comprises controlling a current applied to at least one of the light sources so the applied current varies non-linearly with time.

3. The method according to claim 1, wherein the light-guide structure is configured to scatter the emitted light by volume scattering and/or to redirect the emitted light by outcoupling structures dispersed about exterior surfaces of the light-guide structure or inside the light-guide structure.

4. The method according to claim 1, wherein emitting the dynamically tuned light intensities comprises emitting beams from at least two of the plurality of light sources longitudinally into the light-guide structure so that the beams counter-propagate through at least a section of the light-guide structure.

5. The method according to claim 4, wherein emitting the dynamically tuned light intensities longitudinally into the light-guide structure comprises, for at least one of the light sources, emitting the dynamically tuned light intensity in a first direction and re-directing the emitted dynamically tuned light intensity to a second direction by reflecting from an optical coupling element disposed within the light-guide structure, in which the second direction is the longitudinal direction of the light-guide structure.

6. The method according to claim 4, in which the light-guide structure is arranged to form a closed loop and there are at least four visible light sources spaced about the loop.

7. The method according to claim 4, wherein the light sources are visible light sources, and wherein the light guide structure and visible light sources are disposed in a portable electronic device such that lateral surfaces of the light-guide structure through which the scattered light is output are disposed along an exterior surface of the device.

8. The method according to claim 1, wherein dynamically tuning light intensity from a plurality of correlated light sources is by a controller having an input from at least one sensor, and the light intensities are dynamically tuned in dependence on the at least one sensor input.

9. The method according to claim 1, wherein dynamically tuning light intensity from a plurality of correlated light sources is by a controller having a dynamically updated current position input from at least one of a radio and an inertial navigation system, and the light intensities are dynamically tuned in dependence on the current position input.

10. The method according to claim 1, wherein dynamically tuning light intensity from a plurality of correlated light sources is by a controller having a memory input from a local memory, and the light intensities are dynamically tuned in dependence on the memory input.

11. The method according to claim 10, wherein the memory input comprises at least one of: a geographic map, a predetermined geographic position, a register of identifiers, an address book, and a digital file having an audio component.

12. An apparatus comprising:
a plurality of light sources;
a light-guide structure disposed to longitudinally propagate light emitted by the plurality of light sources through at least a portion of the light-guide structure, and configured to scatter and/or re-direct the emitted light and to output the scattered and/or re-directed light laterally through the light-guide structure; and
a controller configured to dynamically correlate the light emitted from the plurality of light sources and to dynamically tune intensity of the light emitted from the plurality of light sources.

13. The apparatus according to claim 12, wherein the controller is configured to dynamically tune the intensity of the light by controlling current applied to at least one of the light sources so the applied current varies non-linearly with time.

14. The apparatus according to claim 12, wherein the light-guide structure is made of a translucent polymer and is configured to scatter and/or re-direct the emitted light by at least one of:
volume scattering nodes dispersed within a material of the light-guide structure; and
outcoupling structures dispersed about exterior surfaces of the light-guide structure or inside the light-guide structure.

15. The apparatus according to claim 12, wherein at least two of the plurality of light sources are disposed so as to emit beams that counter-propagate relative to one another within the portion of the light-guide structure.

16. The apparatus according to claim 15, in which at least one of the plurality of light sources is disposed to emit light in a first direction and the light guide structure comprises an optical coupling element for re-directing the light emitted in the first direction to a second direction which is the longitudinal direction of the portion of the light-guide structure.

17. The apparatus according to claim 4, in which the light-guide structure is arranged to form a closed loop and there are at least four visible light sources spaced about the loop.

18. The apparatus according to claim 12, wherein the controller comprises an input from the at least one sensor; wherein the controller is configured to dynamically correlate the light emitted and to dynamically tune intensity of the light emitted in dependence on the at least one sensor input.

19. The apparatus according to claim 12, wherein the controller comprises a dynamically updated current position input; and the controller is configured to dynamically correlate the light emitted and to dynamically tune intensity of the light emitted in dependence on the current position input.

20. The apparatus according to claim 12, wherein the controller comprises a memory input from a local memory; and the controller is configured to dynamically correlate the light emitted and to dynamically tune intensity of the light emitted in dependence on the memory input.
